(19) United States
(12) Patent Application Publication
(10) Pub. No.: US 2011/0099483 A1
(43) Pub. Date: Apr. 28, 2011

(54) Website Recording of Reactions of a Designated User through interaction with characters

(76) Inventor: Bruce James Navin, Elizabethtown, PA (US)

(21) Appl. No.: 12/605,347

(22) Filed: Oct. 25, 2009

(51) Int. Cl. G06F 3/00

(52) U.S. Cl. 715/749

(57) ABSTRACT

The current invention is a Website Recording of Reactions of a Designated User through interaction with characters. It consists of a system on a website running on a computer processor where a user can connect to, the system will ask the user questions through the use of animations or recorded scripts, the user will answer these questions, these answers would be recorded by the system through a webcam or similar recording device and this recording would be made available to the user.

### BACKGROUND OF INVENTION

1. Field of Invention

The present invention relates to the recording of the reactions of a designated user and in more particular one that works with the interaction with characters.

2. Description of Prior Art

In the current art, when a parent or someone else wants a recording of the reactions of a designated user for things such as a list of gifts or gift idea from a child or someone else that list is usually done through paper and pencil or through the circling of a catalog or the video taping of the reactions.

Sometimes that list is a Christmas list given to Santa Claus.

There needs to be an easier way to record this list so that it is preserved and can be done in private.

### PRIOR ART

U.S. Pat. No. 7,536,478 by Philyaw, et al. and issued on May 19, 2009 and is for a method and apparatus for opening and launching a web browser in response to an audible signal.

U.S. Pat. No. 7,533,146 by Kumar and issued on May 12, 2009 and is for a Shared web browser apparatus and method for interactive communications. It discloses a shared web browser for simultaneously linking together a plurality of remote locations to deliver live presentations to anyone, anywhere in the world. The web browser can be used either by itself, or in conjunction with a conventional telephone conference call. A personal computer at each location is linked together by means of an Internet connection, wherein one of those computers controls the information displayed on each of the other computers; this is the presenter's function. Each of the other users or participants are referred to as attendees, and the presenter directs information to be displayed on the monitors of all the participants in the conference.

U.S. Pat. No. 7,529,690 by Hadi and issued on May 5, 2009 and is for a System and method for delivering real time remote buying, selling, meeting, and interacting in a virtual reality environment. It discloses a virtual reality interactional system and a method of use in which remote shoppers, remote advisors, remote sales consultants, remote product display agents, real time inventory status, live and stored audio and video content, and client server based virtual programming logic interact in real time to complete soft touch, high touch, and non-high touch products and services transactions. The virtual reality interacting system encompasses a combination of virtual reality hardware, virtual reality programming logic and communication networks. It can be used at homes, offices, virtual reality storefronts, or a combination thereof using high capacity private networks and also the Internet. Business to business, business to consumer, and consumer to consumer interactive interactions can be seamlessly performed by means of the current invention.

U.S. Pat. No. 7,526,786 by Adams, et al. and issued on Apr. 28, 2009 and is for a Content programmer control of video and data display using associated data. It discloses an interactive video system is disclosed that processes a video data stream and an associated data stream corresponding to the video data stream. The interactive video system displays a video image defined by the video data stream on a display device and performs interactive command functions specified by the associated data stream. The interactive command functions include commands that specify placement of a video display window, commands that specify parameters of graphical objects that are associated with the video image and commands that specify pixel data or graphics description for the graphical object and commands for placement of selection windows and that specify interactive functions for the selection windows.

U.S. Pat. No. 7,502,036 by Kramer, et al. and issued on Mar. 10, 2009 and is for a System for delivering and enabling interactivity with images. It discloses a system is disclosed for delivering and displaying images on web pages and enabling and implementing various interactive functions with respect to the images, so as to give a user the illusion that objects or scenes depicted in the images are rotating, being zoomed in on, changing color, being measured, or having certain areas of the objects or scenes highlighted with enlargement and/or text, among other things.

U.S. Pat. No. 7,447,748 by Reynolds, et al. and issued on Nov. 4, 2008 and is for a Interactive web book system. It discloses an interactive Web book (“ibook”) system is provided that allows material to be contributed to the World Wide Web. An ibook is a self-extending, self-sustaining information-redistributing Web robot, which is resident on a data network such as the Internet or an intranet. Users may enroll with an ibook as viewers or contributors. Viewers may view ibook material, such as text or multimedia content.

U.S. Pat. No. 6,173,317 by Chaddha, et al. and issued on Jan. 9, 2001 and is for a Streaming and displaying a video stream with synchronized annotations over a computer network. It discloses where a client computer(s) retrieve and display synchronized annotated multimedia streams from servers dispersed over a diverse computer network which includes local area networks (LANs) and/or wide area networks (WANs) such as the internet.

There is still room for improvement in the art.

### SUMMARY OF INVENTION

The current invention is a Website Recording of Reactions of a Designated User through interaction with characters. It consists of a system on a website running on a computer processor where a user can connect to, the system will ask the user questions through the use of animations or recorded video scripts that are selected in advance by a master user, the user will answer these questions, these answers would be recorded by the system through a webcam or similar recording device and this recording would be made available to the Master user.

The current invention utilizes the Internet but it also can be done as a stand alone application. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

The system is more efficient, effective, accurate and functional than the current art.

### DEFINITIONS

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Without restricting the full scope of this invention, the preferred form of this invention is illustrated in the following drawings:

FIG. 1a shows an overview of how a User accesses the system through the Internet;

FIG. 1b shows an overview of how a User accesses the system on a stand alone system;

FIG. 2 shows an overall view of the system;

FIG. 3 displays the webcam taking a picture of the user;

FIG. 4 displays some of the images of the characters;

FIG. 5 shows the user viewing the interactive session;

FIG. 6 shows the clearing out of stored sessions;

FIG. 7 displays a cartoon character; and

FIG. 8 displays a flowchart of the system.

### DETAILED DESCRIPTION

The following description is demonstrative in nature and is not intended to limit the scope of the invention or its application of uses.

There are a number of significant design features and improvements incorporated within the invention.

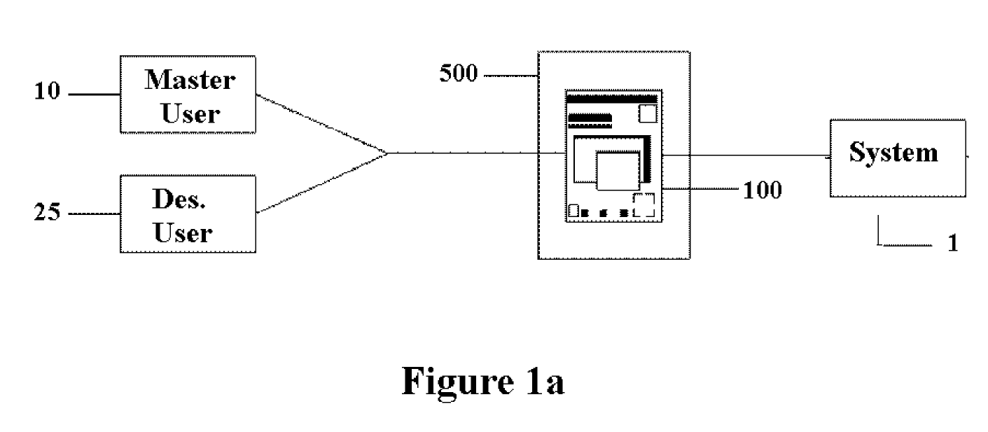

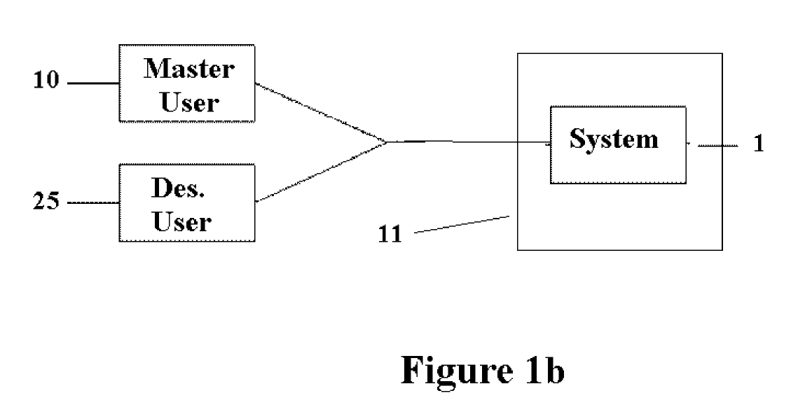

As shown in FIG. 1a, the current invention is a System 1, which provides a Website Recording of Reactions of a Designated User through interaction with characters or images. The computer application that includes the user interface for this invention will henceforth be referred to as “the System 1.” The system is network-based and works on an Internet, Intranet, and/or Wireless network basis as well as a stand alone based system as shown in FIG. 1b.

In the preferred embodiment the system 1 runs on a website running on a computer processor. The system 1 is written in a program language the changes the electronic memory of the computer processor to run. A designated user 25 connects to the system 1. The system 1 will ask the designated user 25 such as a child questions through the use of animations or recorded scripts and the designated user 25 will answer these questions. These answers would be recorded by the system 1 through a webcam or similar recording device and this recording would be made available to the master user 10 such as a parent.

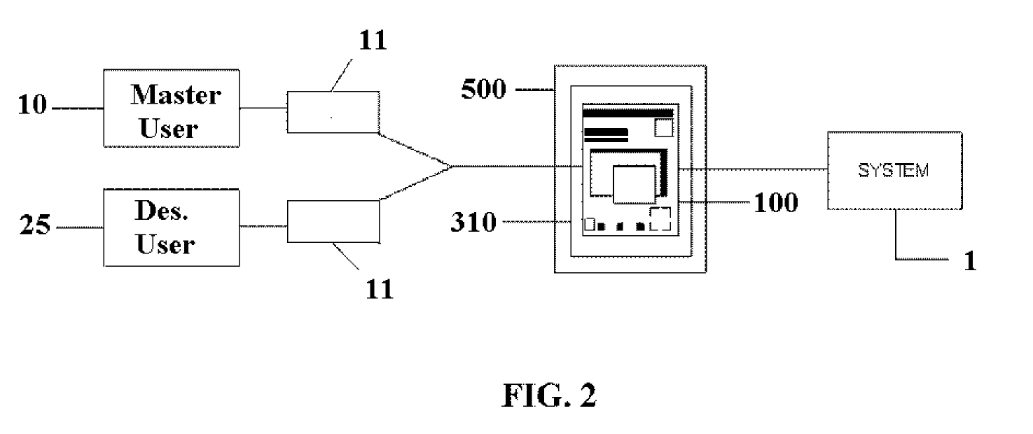

FIG. 2 illustrates a functional diagram of a computer network for World Wide Web 500 access to the System 1 from a plurality of master users 10 and designated users 25 who accesses the system Web Site 100 or the master users 10 and designated users 25 can connect directly to the System 1 using their computer 11. Accessing the System Web Site 100 can be accomplished directly through a communication means such as a direct connection, an intranet, a local Internet Service Provider, often referred to as ISPs, or through an on-line service provider or Wireless devices. The system 1 can also be run as a stand alone program on a computer 11 or a network.

The master users 10 and designated users 25 contacts the System Web Site 100 using an informational processing system (Client) capable of running an HTML compliant Web browser. A typical system that is used is a personal computer with an operating system running a Web browser. The exact hardware configuration of computer used by the master users 10 and designated users 25, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the master users 10 and designated users 25 connects to the System Web Site 100. In the preferred embodiment the system has numerous web pages. The information in the web pages are in HTML format via the HyperText Transport Protocol (http) and on Server System 310. The User System 310 includes software to allow viewing of web pages, commonly referred to as a Web Browser. The user system is capable of accessing web pages located on Server System 310.

The system 1 is set to run on a computing device. A computing device on which the present invention can run would be comprised of a CPU, Hard Disk Drive, Keyboard, Monitor, CPU Main Memory, and a portion of main memory where the system resides and executes. A printer can also be included. Any general purpose computer 11 with an appropriate amount of storage space is suitable for this purpose. Computer Devices like this are well known in the art and are not pertinent to the invention. The system can also be written in a number of different languages and run on a number of different operating systems and platforms. The master users 10 and designated users 25 will also be using a computing device to connect to the system 1.

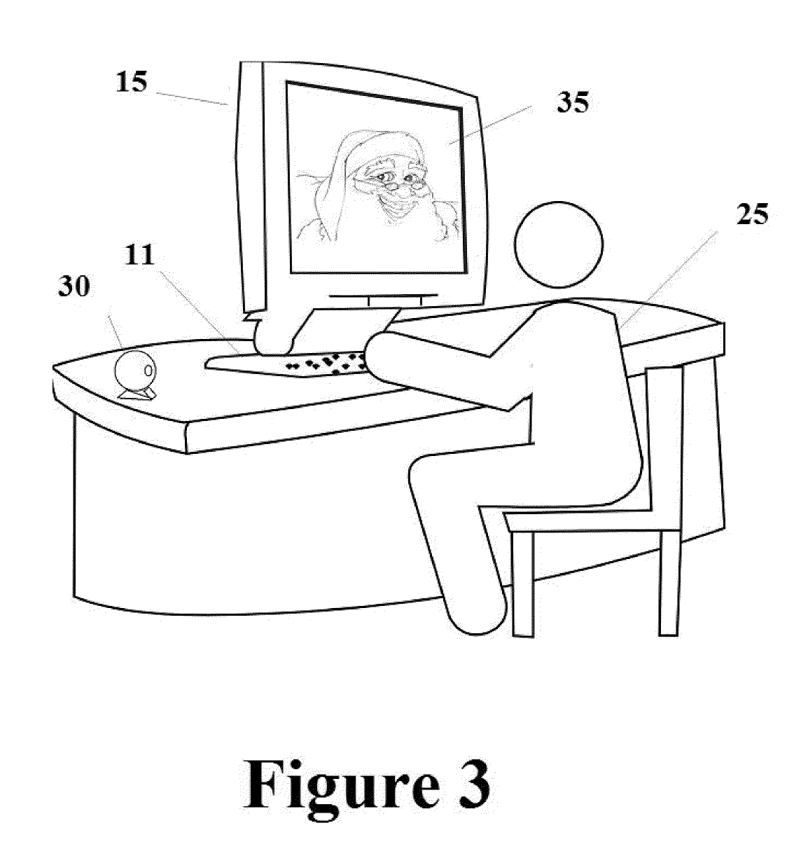

FIG. 3 displays how an interactive session is recorded. The designated user 25, such as a child or employee, answering the questions is in front of the computer screen 15 where the characters 35 are asking the questions. A webcam 30 also faces the designated user 25 recording their answers 40. The recorded interactive session is then stored on the system 1 for viewing and retrieval.

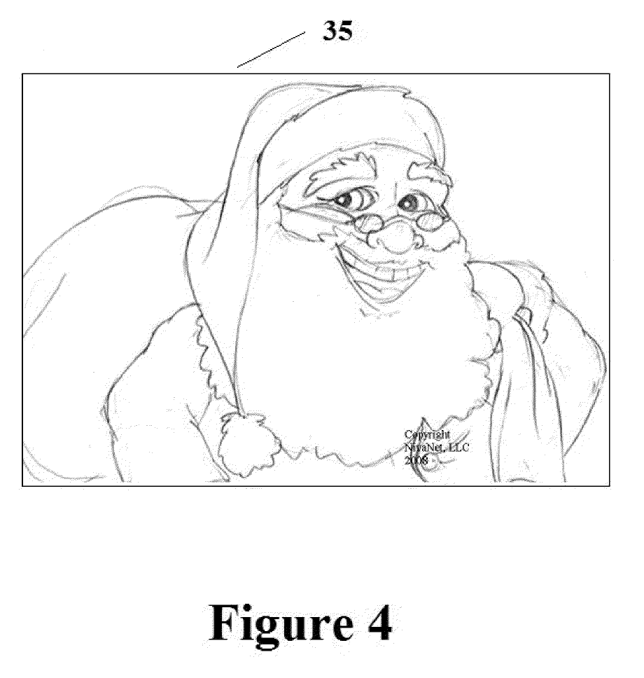

FIG. 4 shows a sample character 35 which is in this case, Santa Claus.

In one preferred embodiment of the invention, the Master User 10 such as a parent or employer, connects to the Web site 100. The system 1 would have a standard home web at the System Web Site 100 for the master users 10. This home web page would have information about the system 1 as well as a standard login. The web page would have an area where the master user 10 would enter their information such as name, login, and address and what interactive session that they are interested in and who is the designated user(s) 25 that will be participating.

In the preferred embodiment the buyer would be a master user 10 such as a parent or subscriber client or employer. There would also be a designated user 25 such as a child or test subject or employee or interviewee.

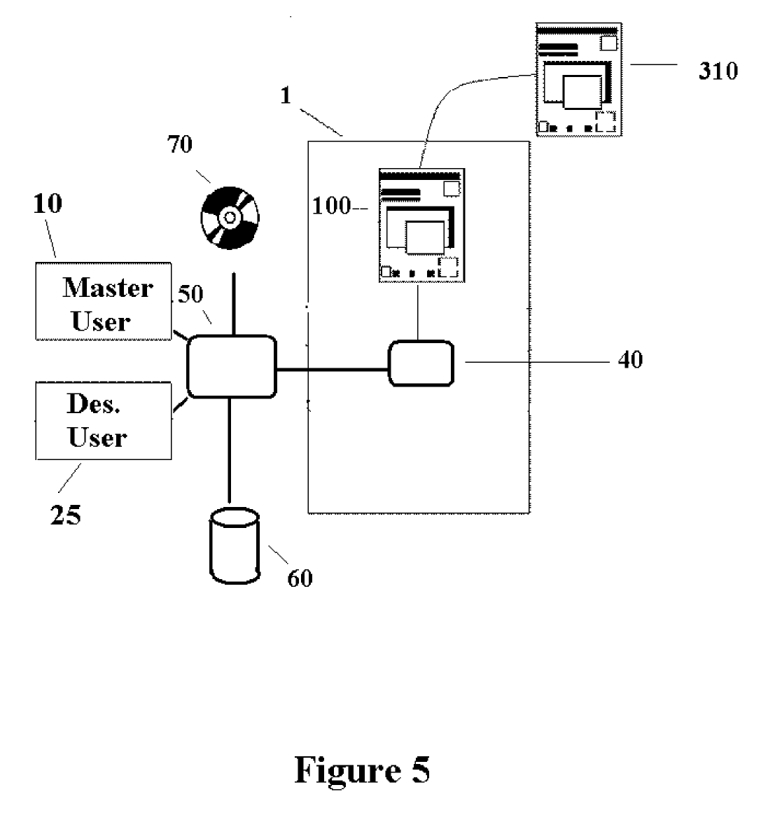

The system 1 will allow the Master users 10 to view the answers 40 to the interactive session in the form of a video feed 50. This video feed 50 can also be downloaded in the form of a download 60 by the Master user 10 or sent to them by the system 1 in a storage means such as a CD 70 as shown in FIG. 5. The Master user 10 could also send it via an E-mail attachment or upload it to a website or onto a social posting site after they have the download 60.

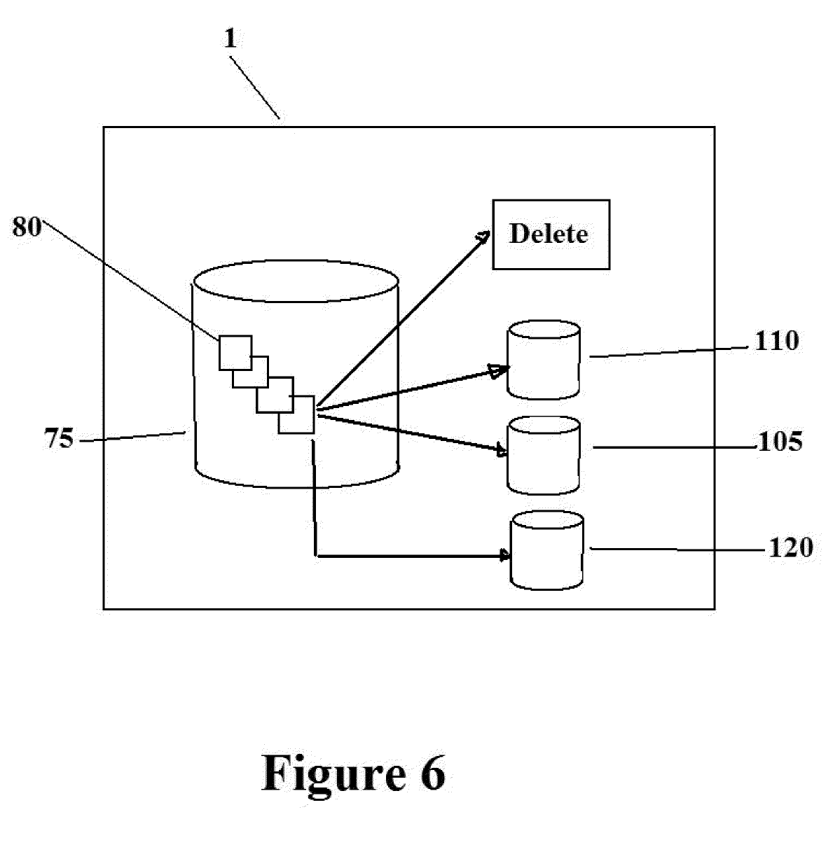

In the preferred embodiment the system 1 will clear out the stored recorded interactive sessions 80 on a periodic basis such as annually. This is done to clear out memory storage space 75. The parent or master user 10 will be able to download 105 or get a copy of the sessions 80 prior to this being done. The stored recorded interactive sessions 80 can also be loaded in a backup 110 or long term storage device 120 for later retrieval as shown in FIG. 6.

The questions asked can be a preset set of questions or questions that are inputted from the Master user 10 from a list or a free formatted set of questions from the master user 10.

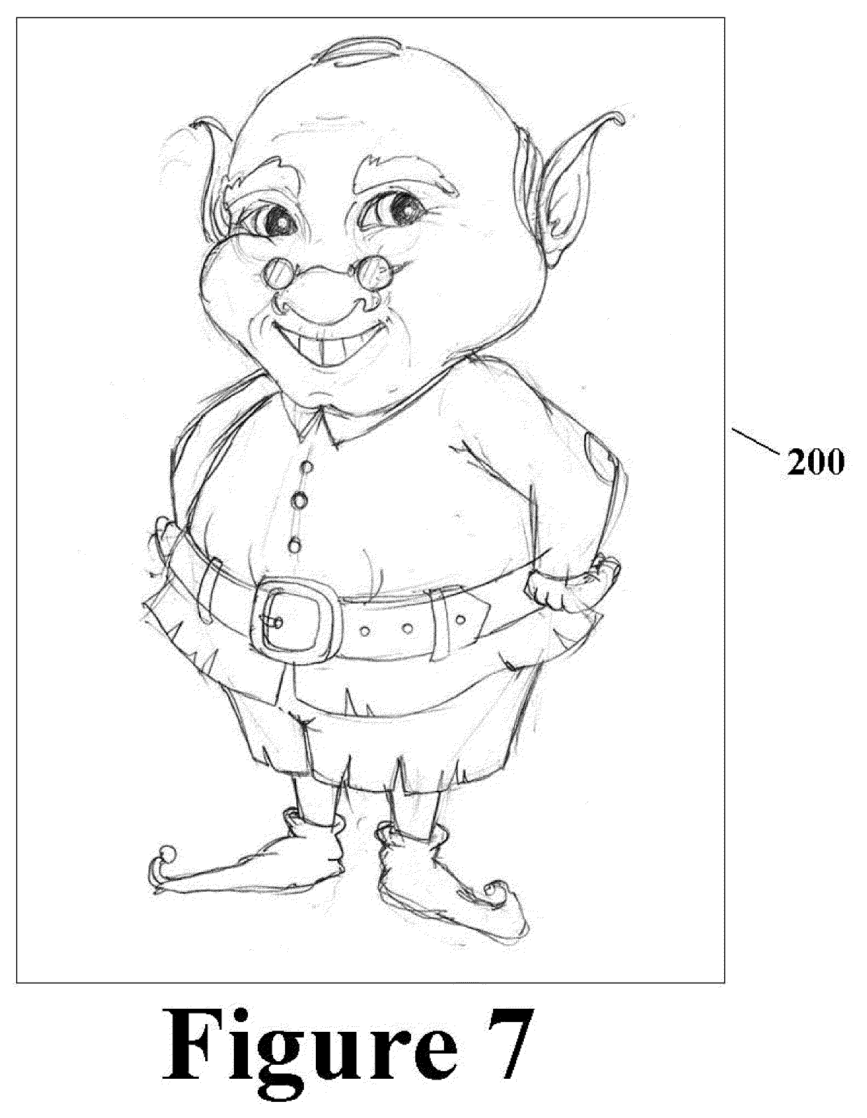

The image 200, as shown in FIG. 7 can be a cartoon character or a real person.

This system 1 is very well designed for the asking of children their Christmas Lists with the child interacting with Santa, Mrs. Claus and/or Elves. The recording of their Christmas wishes can then be provided to their parents who can use these lists to purchase gifts for their Child as well as a treasured keepsake.

The system 1 can also be used for purposes of Recordings being provided to employers or other type of evaluators to review the reactions of the designated user 25 where the designated user is an employee or interviewee and the questions are set by the employer or other type of evaluator.

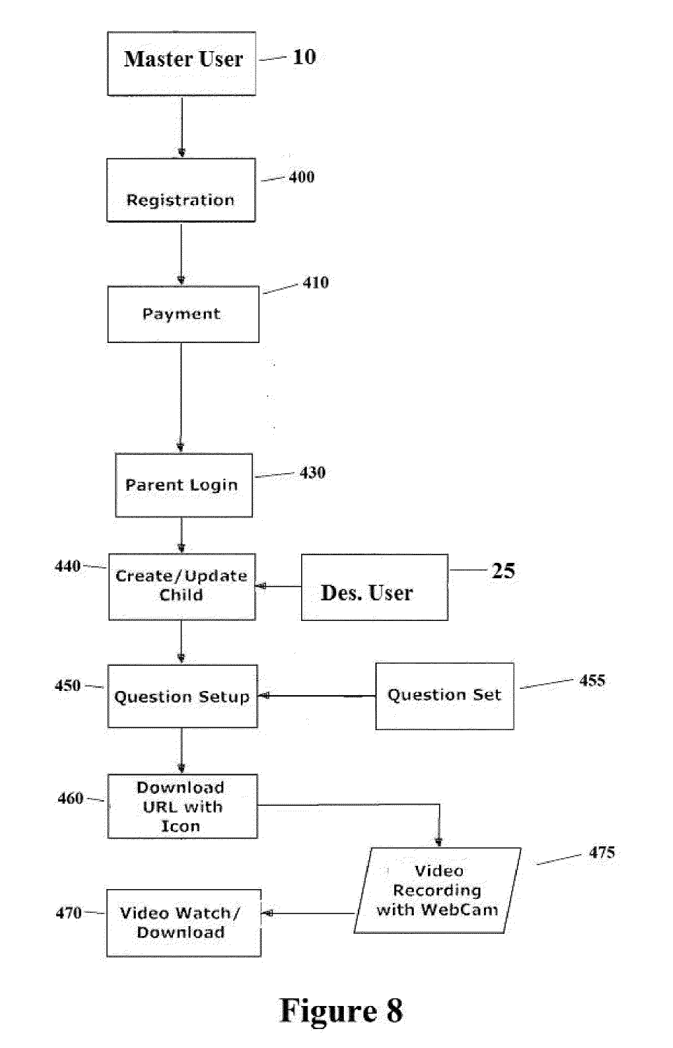

FIG. 8 is a flow diagram of the process the system 1 uses. In one embodiment, this process is used to provide a children's Christmas list to a parent serving as a master user 10. A parent serving as the master user 10 would log on to the system 1 and register 400, then make a payment 410 for the services. In the preferred embodiment, the system 1 would not have any sort of approval regime other than a brief delay for approval of payment with the Parent or Master User 10 instantly selecting a password, and use their email address as the user name. The parent serving as the master user 10 would use the information to login 430 to the system 1. The parent serving as the master user 10 would create and/or update the record 440 for each child serving as the designated user 25 that will be using the system 1. The parent serving as the master user 10 would setup the questions 450 that are going to be asked to the child serving as the designated user 25 or use previous questions 455. The parent serving as the master user 10 would download 460 the child's URL for use by the child in their role as the designated user 25. The child acting as the designated user 25 would record their list 475 with a webcam 30 and the system 1 would allow that video to be downloaded 470 or watched by the master user 10 who in this case would be the parent.

### Advantages

No prior art will allow for the ease and practicality of the recording answers using interactive characters as laid out in the current invention.

### CONCLUSION

The system 1 is set to run on a computing device. A computing device on which the present invention can run would be comprised of a CPU, Hard Disk Drive, Keyboard, Monitor, CPU Main Memory and a portion of main memory where the system resides and executes. A printer can also be included. Any general purpose computer with an appropriate amount of storage space is suitable for this purpose. Computer Devices like this are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

What is claimed is:

1. A method of recording answers, the method comprising:
having a system running on a computer processor where a user can connect to, having said system ask a designated person questions through the use of animations, having said designated person answer these questions, having these answer recorded by the system through a recording device and allowing access to said recording.

2. A method of recording answers according to claim 1 further comprising:
having said system make statements intended to illicit a response.

3. A method of recording answers according to claim 1 further comprising:
having said system make statements intended to illicit multiple responses.

4. A method of recording answers according to claim 1 further comprising:
having said user access the system through the Internet.

5. A method of recording answers according to claim 1 further comprising:
having said system run on a computer device.

6. A method of recording answers according to claim 1 further comprising:
having said system transfer said recording.

7. A method of recording answers according to claim 1 further comprising:
having said system transfer said recording by a download.

8. A method of recording answers according to claim 1 further comprising:
having said system backup said recording.

9. A method of recording answers according to claim 1 further comprising:
having said system being used to record a gift list.

10. A method of recording answers according to claim 9 further comprising:
having said system being used to record a Christmas gift list with said video presentation being from Christmas characters.

11. A method of recording answers, the method comprising:
having a system running on a computer processor where a user can connect to, having said system ask a designated person questions through the use of pre-recorded video presentations, having said designated person answer these questions, having these answer recorded by the system through a recording device and allowing access to said recording.

12. A method of recording answers according to claim 11 further comprising:
having said system make statements intended to illicit a response.

13. A method of recording answers according to claim 11 further comprising:
having said system make statements intended to illicit multiple responses.

14. A method of recording answers according to claim 11 further comprising:
having said user access the system through the Internet.

15. A method of recording answers according to claim 11 further comprising:
having said system run on a computer device.

16. A method of recording answers according to claim 11 further comprising:
having said system transfer said recording.

17. A method of recording answers according to claim 11 further comprising:
having said system transfer said recording by a download.

18. A method of recording answers according to claim 11 further comprising:
having said system backup said recording.

19. A method of recording answers according to claim 11 further comprising:
having said system being used to record a gift list.

20. A method of recording answers according to claim 19 further comprising:
having said system being used to record a Christmas gift list with said video presentation being from Christmas characters.
